(19) United States
(12) Patent Application Publication
(10) Pub. No.: US 2006/0052106 A1
(43) Pub. Date: Mar. 9, 2006

(54) Method and apparatus for performing fast handover

(75) Inventor: Soo-hong Park, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/218,560

(22) Filed: Sep. 6, 2005

Related U.S. Application Data
(60) Provisional application No. 60/606,896, filed on Sep. 3, 2004.

(30) Foreign Application Priority Data
Sep. 10, 2004 (KR) 10-2004-0072675

(51) Int. Cl. H04Q 7/20

(52) U.S. Cl. 455/436

(57) ABSTRACT

A method of performing, and an apparatus to perform, handover in a mobile node, the method including selectively performing the handover according to neighbor information received from a predetermined access point, wherein the neighbor information comprises information regarding at least one access point neighboring the predetermined access point.

### CROSS-REFERENCE TO RELATED APPLICATIONS

This application claims the benefit of Korean Patent Application No. 10-2004-0072675, filed on Sep. 10, 2004, in the Korean Intellectual Property Office, and the benefit of U.S. Provisional Patent Application No. 60/606,896, filed on Sep. 3, 2004, in the U.S. Patent and Trademark Office, the disclosures of which are incorporated herein by reference.

### BACKGROUND OF THE INVENTION

1. Field of the Invention

The present invention relates to a method of performing, and an apparatus to perform, handover in a wireless Local Area Network (LAN) environment, and, more particularly, to a method of performing, and an apparatus to perform, fast handover in a wireless LAN environment based on the Institute of Electrical and Electronics Engineers (IEEE) 802.11 standard.

2. Description of the Related Art

With the increasing popularity of multimedia mobile communication services, it is necessary to provide users on the move with seamless communication service. Fast handover has been considered an important topic in an IEEE 802.11 standard-based wireless LAN environment.

FIG. 1 is a diagram of a conventional wireless LAN environment. Referring to FIG. 1, the wireless LAN environment comprises a mobile node (MN) 1, access point (AP) A 21, access point B 22, access point C 23, access point D 24, access router (AR) A 31, and access router B 32.

The mobile node 1 moves among a plurality of wireless LANs, and may be a mobile phone, personal digital assistant (PDA), notebook computer, or similar device. AP A 21, AP B 22, AP C 23, and AP D 24 each connect the mobile node 1 to a subnet in which the access points are located, to allow the mobile node 1 to connect to a wired network such as the Internet. AR A 31 and AR B 32 provide the mobile node 1 with routing service in subnets in which the access routers are located, to allow the mobile node 1 to connect to a subnet node by the optimum path.

The conventional wireless LAN environment will now be described for a case in which the mobile node 1 sequentially goes through a Basic Service Set (BSS) operated by AP A 21, a BSS operated by AP B 22, a BSS operated by AP C 23, and a BSS operated by AP D 24, as shown in FIG. 1. BSS is a term used in the IEEE 802.11 standard, and refers to a wireless LAN operated by an access point.

AP A 21, AP B 22, AP C 23, and AP D 24 periodically transmit a beacon signal that indicates their BSSs in order to inform the moving mobile node 1 of the AP through which it connects to a wired network.

In communication 211, the mobile node 1 receives a beacon signal from AP A 21. The mobile node 1 is aware of being continuously located in the BSS operated by AP A 21 according to the beacon signal. The mobile node 1 connects to the wired network through AP A 21.

In communication 221, the mobile node 1 receives a beacon signal from AP B 22. The mobile node 1 is aware of a change of the BSS in which the mobile node 1 is located, according to the beacon signal. The mobile node 1 performs handover in a link layer according to the change of BSS. To be more specific, the mobile node 1 is aware of being located in the BSS operated by AP B 22, and changes a link layer connection with AP A 21 to a link layer connection with AP B 22. In accordance with an open systems interconnection (OSI) reference model, since the link layer is referred to as a second layer, handover in the link layer is called handover in the second layer, abbreviated to L2 handover. The mobile node 1 then connects to the wired network through AP B 22.

In communication 222, the mobile node 1 transmits a router solicitation for proxy advertisement (RtSolPr) frame, including information on the change of the BSS in which the mobile node 1 is located, to AR A 31 through AP B 22. Since the mobile node 1 directly transmits the frame to AR A 31 without going through AR B 32, AR A 31 is aware that the mobile node 1 is continuously located in a subnet operated by AR A 31.

In communication 223, AR A 31 transmits a proxy router advertisement (PrRtAdv) frame, including information regarding no change occurring in the subnet, to the mobile node 1 through AP B 22. The mobile node 1 receives the frame and is aware of being continuously located in the subnet operated by AR A 31. The mobile node 1 does not perform handover in an Internet protocol (IP) layer, since there is no change in the subnet. In accordance with the OSI reference model, since the IP layer is referred to as a third layer, handover in the IP layer is called handover in the third layer, or L3 handover.

In communication 224, the mobile node 1 receives a beacon signal from AP B 22. The mobile node 1 is aware of being continuously located in the BSS operated by AP B 22 according to the beacon signal. The mobile node 1 continues to connect to the wired network through AP B 22.

In communication 231, the mobile node 1 receives a beacon signal from AP C 23. The mobile node 1 is aware of a change of the BSS in which the mobile node 1 is located according to the beacon signal. The mobile node 1 performs handover in the link layer according to the change of the BSS. To be more specific, the mobile node 1 is aware of being located in the BSS operated by AP C 23, and changes the link layer connection with AP B 22 to a link layer connection with AP C 23. The mobile node 1 connects to the wired network through AP C 23.

In communication 232, the mobile node 1 transmits the RtSolPr frame, including information regarding the change in the BSS in which the mobile node 1 is located, to AR A 31 through AP C 23 and AR B 32. AR A 31, which receives the frame through AR B 32, is aware that the mobile node 1 is out of the subnet operated by AR A 31.

In communication 233, ARA 31 transmits the PrRtAdv frame, including information regarding the change in the subnet in which the mobile node 1 has been located, to the mobile node 1 through AR B 32 and AP C 23. The mobile node 1 receives the frame and is aware of the change in the subnet. The mobile node 1 performs handover in the IP layer due to the change in the subnet.

In communication 234, the mobile node 1 receives a beacon signal from AP C 23. The mobile node 1 is aware of being continuously located in the BSS operated by AP C 23 according to the beacon signal. The mobile node 1 continues to connect to the wired network through AP C 23.

In communication 241, the mobile node 1 receives a beacon signal from AP D 24. The mobile node 1 is aware of a change of the BSS in which the mobile node 1 is located according to the beacon signal. The mobile node 1 performs handover in the link layer according to the change of the BSS. To be more specific, the mobile node 1 is aware of being located in the BSS operated by AP D 24, and changes the link layer connection with AP C 23 to a link layer connection with AP D 24. The mobile node 1 connects to the wired network through AP D 24.

In communication 242, the mobile node 1 transmits the RtSolPr frame, including information regarding the change in the BSS in which the mobile node 1 is located, to AR B 32 through AP D 24. Since the mobile node 1 directly transmits the frame to AR B 32 without going through AR A 31, AR B 32 is aware that the mobile node 1 is continuously located in the subnet operated by AR B 32.

In communication 243, AR B 32 transmits the PrRtAdv frame, including information regarding no change occurring in the subnet, to the mobile node 1 through AP D 24. The mobile node 1 receives the frame and is aware of being continuously located in the subnet operated by AR B 32. The mobile node 1 does not perform handover in the IP layer, since there is no change in the subnet.

As described above, since a mobile node is not aware of changes in the subnet in which it is located, the mobile node communicates with an access router in order to obtain such information. That is, the mobile node communicates with the access router in order to determine whether to perform handover in the link layer, or handover in both the IP layer and the link layer.

When the mobile node performs handover only in the link layer, the mobile node not only communicates with an access point in the link layer but also communicates with the access router in the IP layer. In other words, whenever a BSS in which the mobile node is located is changed, the mobile node must communicate with the access router through the access point. This communication presents a problem in achieving fast handover.

### SUMMARY OF THE INVENTION

The present invention provides an apparatus to perform, and a method of performing, handover in a link layer, as well as an IP layer, using link layer communication between a mobile node and access point without IP layer communication between the mobile node and an access router.

The present invention also provides a computer readable medium having embodied thereon a computer program to execute the method.

Additional aspects and/or advantages of the invention will be set forth in part in the description which follows and, in part, will be apparent from the description, or may be learned by practice of the invention.

According to an aspect of the present invention, there is provided a method of performing handover in a mobile node, the method comprising: receiving neighbor information, obtained by a predetermined access point from at least one access point neighboring the predetermined access point, to allow the mobile node to connect to a subnet among a plurality of subnets; and selectively performing the handover according to a change in the subnet that is connected to the mobile node based on the received neighbor information.

According to another aspect of the present invention, there is provided an apparatus to perform handover in a mobile node, comprising: a receiver to receive neighbor information, obtained by a predetermined access point from at least one access point neighboring the predetermined access point, to allow the mobile node to connect to a subnet among a plurality of subnets; and a handover performer to selectively perform the handover according to a change in the subnet that is connected to the mobile node, based on the neighbor information received by the receiver.

According to still another aspect of the present invention, there is provided a computer readable medium having embodied thereon a computer program to execute the method of performing the handover in a mobile node.

According to yet another aspect of the present invention, there is provided a method of supporting handover in a predetermined access point to allow a mobile node to connect to a subnet among a plurality of subnets, the method comprising: obtaining neighbor information from at least one access point neighboring the predetermined access point; and transmitting the obtained neighbor information to the mobile node; wherein the mobile node selectively performs the handover according to a change in the subnet that is connected to the mobile node based on the received neighbor information.

According to a further aspect of the present invention, there is provided an apparatus to support handover in a predetermined access point to allow a mobile node to connect to a subnet among a plurality of subnets, the apparatus comprising: a neighbor information obtainer to obtain neighbor information from at least one access-point neighboring the predetermined access point; and a transmitter to transmit the neighbor information obtained by the neighbor information obtainer to the mobile node; wherein the mobile node selectively performs the handover according to a change in the subnet that is connected to the mobile node based on the received neighbor information.

According to a further aspect of the present invention, there is provided a computer readable medium having embodied thereon a computer program to execute the method of supporting the handover.

According to a further aspect of the present invention, there is provided a frame including neighbor information, obtained by a predetermined access point from at least one access point neighboring the predetermined access point, to allow a mobile node to connect to a subnet among a plurality of subnets, the frame comprising: a field to record an ID of an access router that provides routing service in the subnet in which the neighboring access point is located.

According to another aspect of the present invention, there is provided a method of performing handover in a mobile node, the method comprising selectively performing the handover according to neighbor information received from a predetermined access point; wherein the neighbor information comprises information regarding at least one access point neighboring the predetermined access point.

According to another aspect of the present invention, there is provided a method of performing handover in a mobile node, the method comprising: selectively performing the handover according to neighbor information received from a predetermined access point, without IP layer communication between the mobile node and an access router; wherein the neighbor information comprises information regarding at least one access point neighboring the predetermined access point.

According to another aspect of the present invention, there is provided a method of performing handover in a mobile node, the method comprising: receiving neighbor information from a predetermined access point before performing the handover, the neighbor information comprising information regarding at least one access point neighboring the predetermined access point; and connecting to a subnet neighboring a subnet in which the mobile node is currently located; wherein the neighbor information includes an access router identifier identifying the neighboring subset.

According to another aspect of the present invention, there is provided a method of performing handover in a mobile node, the method comprising: receiving neighbor information, obtained by a predetermined access point from at least one access point neighboring the predetermined access point; and performing the handover in a link layer according to the neighbor information.

According to another aspect of the present invention, there is provided an apparatus to perform handover in a mobile node, comprising: a receiver to receive neighbor information from a predetermined access point regarding at least one access point neighboring the predetermined access point; and a handover performer to selectively perform the handover according to the neighbor information.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a conventional wireless LAN environment;

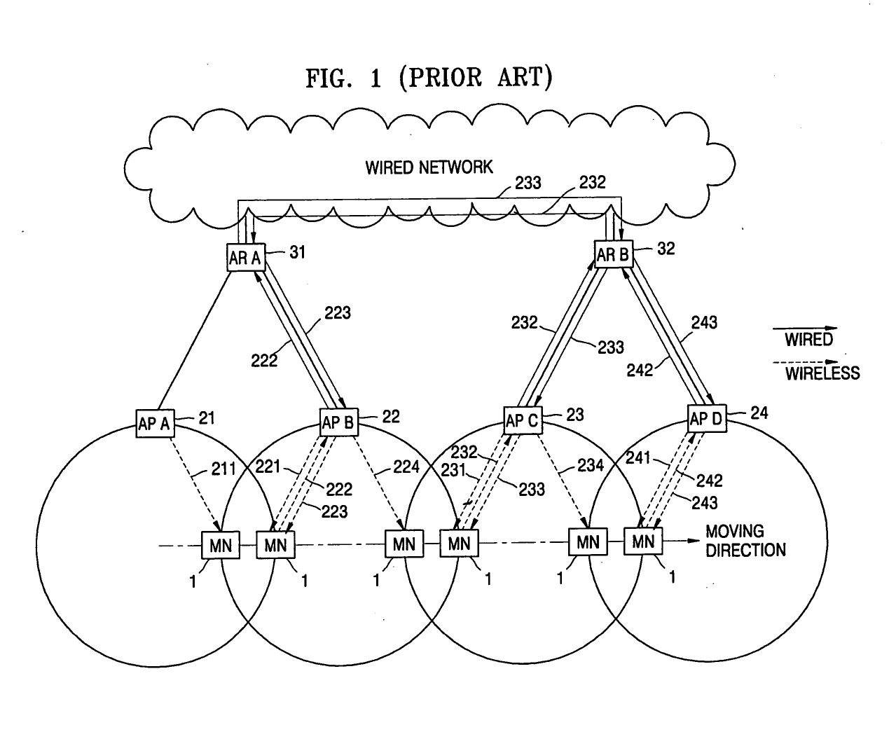

FIG. 2 is a diagram of a wireless LAN environment according to an embodiment of the present invention;

FIG. 3 is a diagram of an apparatus to perform fast handover according to an embodiment of the present invention;

FIG. 4 is a diagram of a neighbor report request frame format based on the Institute of Electrical and Electronics Engineers (IEEE) 802.11 standard;

FIG. 5 is a diagram of a neighbor report response frame format according to an embodiment of the present invention;

FIG. 6 is a diagram of a hot spot environment to which the wireless LAN environment shown in FIG. 2 is applied;

FIG. 7 is a diagram of a university communication environment to which the wireless LAN environment shown in FIG. 2 is applied;

FIG. 8 is a flow chart of a method of performing fast handover according to an embodiment of the present invention; and

FIG. 9 is a flow chart of a method of supporting fast handover according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

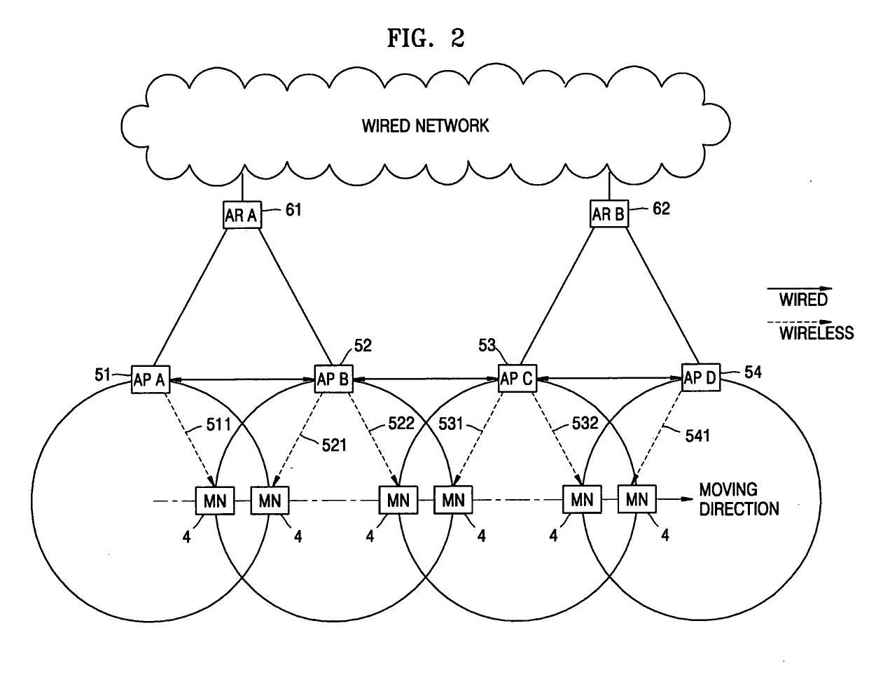

FIG. 2 is a diagram of a wireless local area network (LAN) environment according to an embodiment of the present invention. Referring to FIG. 2, the wireless LAN environment comprises a mobile node 4, access point (AP) A 51, access point B 52, access point C 53, access point D 54, access router (AR) A 61, and access router B 62.

The wireless LAN environment according to this embodiment of the present invention will be described for a case in which the mobile node 4 sequentially goes through a Basic Service Set (BSS) operated by AP A 51, a BSS operated by AP B 52, a BSS operated by AP C 53, and a BSS operated by AP D 54, as shown in FIG. 2.

AP A 51, AP B 52, AP C 53, and AP D 54 periodically transmit neighbor information in order to inform the moving mobile node 4 of the AP through which it is connected to a wired network, in the optimum wireless LAN environment. Neighbor information is referred to as radio resource information, obtained by an access point from neighboring access points, and is used to express a BSS and subnet.

In communication 511, the mobile node 4 receives neighbor information from AP A 51. Neighbor information is obtained from AP B 52 by AP A 51. The mobile node 4 selects an access point capable of providing the optimum wireless LAN environment according to the received neighbor information. Since the mobile node 4 is closer to AP A 51 than AP B 52, the mobile node 4 selects AP A 51, as it allows better reception. Therefore, the mobile node 4 connects to a wired network through AP A 51.

In communication 521, the mobile node 4 receives neighbor information from AP B 52. Neighbor information is obtained from AP A 51 and AP C 53 by AP B 52. The mobile node 4 selects an access point capable of providing the optimum wireless LAN environment according to the received neighbor information. Since the mobile node 4 is closer to AP B 52 than AP A 51, the mobile node 4 selects AP B 52, as it allows better reception. The mobile node 4 performs handover in the link layer according to a change in the BSS. To be more specific, the mobile node 4 selects AP B 52, which is capable of providing the optimum wireless LAN environment, and changes a link layer connection with AP A 51 to a link layer connection with AP B 52. Therefore, the mobile node 4 connects to the wired network through AP B 52.

In communication 522, the mobile node 4 receives neighbor information from AP B 52. Neighbor information is obtained from AP A 51 and AP C 53 by AP B 52. The mobile node 4 selects an access point capable of providing the optimum wireless LAN environment according to the received neighbor information. Since the mobile node 4 is closer to AP B 52 than AP C 53, the mobile node 4 selects AP B 52, as it allows better reception. Therefore, the mobile node 4 connects to a wired network through AP B 52.

In communication 531, the mobile node 4 receives neighbor information from AP C 53. Neighbor information is obtained from AP B 52 and AP D 54 by AP C 53. The mobile node 4 selects an access point capable of providing the optimum wireless LAN environment according to the received neighbor information. Since the mobile node 4 is closer to AP C 53 than AP B 52, the mobile node 4 selects AP C 53, as it allows better reception. The mobile node 4 performs handover in the link layer according to a change in the BSS. To be more specific, the mobile node 4 selects AP C 53, which is capable of providing the optimum wireless LAN environment, and changes the link layer connection with AP B 52 to a link layer connection with AP C 53. Therefore, the mobile node 4 connects to the wired network through AP C 53.

In response to connecting to the wired network through AP C 53, which results from communication 531, the mobile node 4 enters a new subnet. Therefore, the mobile node 4 is aware of a difference between the previous subnet and the new subnet, according to the received neighbor information. The mobile node 4 performs handover in an IP layer according to the change in the subnet.

In communication 532, the mobile node 4 receives neighbor information from AP C 53. Neighbor information is obtained from AP B 52 and AP D 54 by AP C 53. The mobile node 4 selects an access point capable of providing the optimum wireless LAN environment according to the received neighbor information. Since the mobile node 4 is closer to AP C 53 than AP D 54, the mobile node 4 selects AP C 53, as it allows better reception. Therefore, the mobile node 4 connects to the wired network through AP C 53.

In communication 541, the mobile node 4 receives neighbor information from AP D 54. Neighbor information is obtained from AP C 53 by AP D 54. The mobile node 4 selects an access point capable of providing the optimum wireless LAN environment according to the received neighbor information. Since the mobile node 4 is closer to AP D 54 than AP C 53, the mobile node 4 selects AP D 54, as it allows better reception. The mobile node 4 performs handover in the link layer according to the change in the BSS. To be more specific, the mobile node 4 selects AP D 54, which is capable of providing the optimum wireless LAN environment, and changes the link layer connection with AP C 53 to a link layer connection to AP D 54. Therefore, the mobile node 4 connects to the wired network through AP D 54.

The mobile node 4 according to the present embodiment can perform handover based on the neighbor information transmitted from an access point, without communicating with an access router. In particular, the mobile node 4 can perform fast handover in the link layer and IP layer using link layer communication between the mobile node and access point, without IP layer communication between the mobile node and access router.

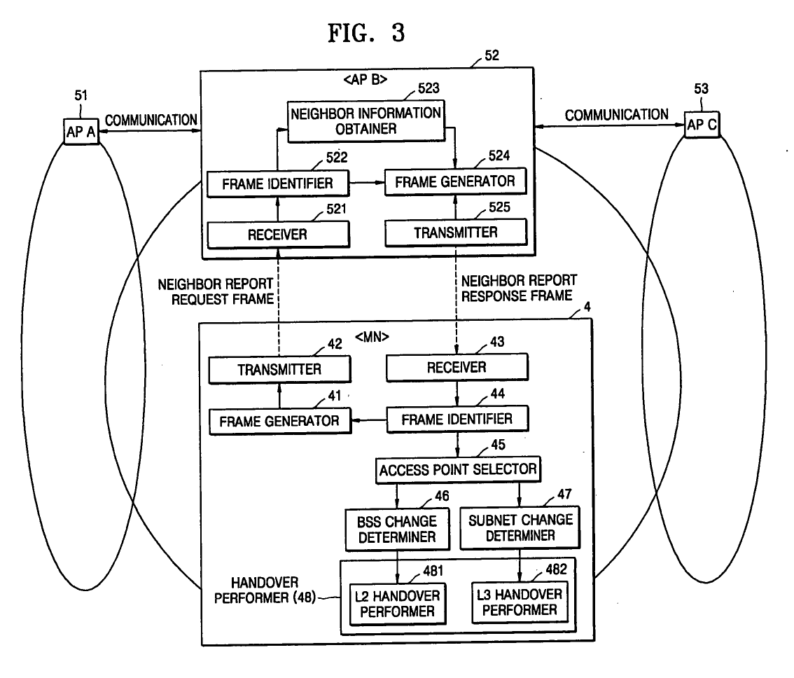

FIG. 3 is a diagram of an apparatus to perform fast handover according to an embodiment of the present invention. Referring to FIG. 3, the apparatus to perform fast handover comprises a frame generator 41, a transmitter 42, a receiver 43, a frame identifier 44, an access point selector 45, a BSS change determiner 46, a subnet change determiner 47, and a handover performer 48. The apparatus to perform fast handover is formed in a link layer of the mobile node 4.

The frame generator 41 generates a neighbor report request frame in order to request neighbor information obtained by AP B 52, which communicates with the mobile node 4. Neighbor information is referred to as radio resource information obtained by AP B 52 from its neighbors AP A 51 and AP C 53.

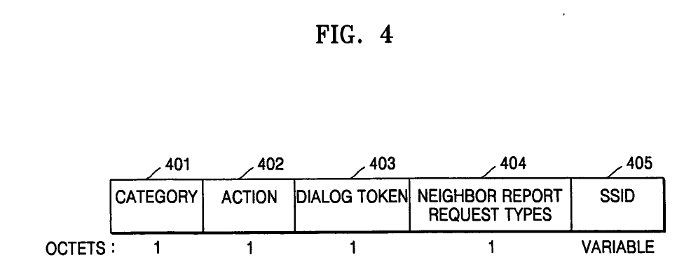

FIG. 4 is a diagram of a neighbor report request frame format based on the Institute of Electrical and Electronics Engineers (IEEE) 802.11 standard. Referring to FIG. 4, the neighbor report request frame based on the IEEE 802.11 standard comprises a category field 401, an action field 402, a dialog token field 403, a neighbor report request type field 404, and a service set identification (SSID) field 405. The IEEE 802.11 standard is used to measure radio resources in order to more effectively manage radio resources in the link layer.

The category field 401 is used to record a radio measurement category value.

The action field 402 is used to record a neighbor report request value.

The dialog token field 403 is used to record a report/request transaction identification value.

The neighbor report request type field 404 is composed of a neighbor target beacon transmission time (TBTT) offset field and a reserved field. When the neighbor TBTT offset field value is 1, a response frame must include a TBTT offset and a beacon interval field.

The SSID field 405 is used to record a value of extended service set (ESS) requiring neighbor information.

The transmitter 42 transmits the neighbor report request frame generated by the frame generator 41 to AP B 52.

The receiver 43 receives a frame from AP B 52.

The frame identifier 44 determines whether the frame received by the receiver 43 is the neighbor report response frame in response to the neighbor report request frame transmitted by the transmitter 42. When there is no neighbor report response frame after a certain time, the frame identifier 44 instructs the frame generator 41 to generate the neighbor report request frame.

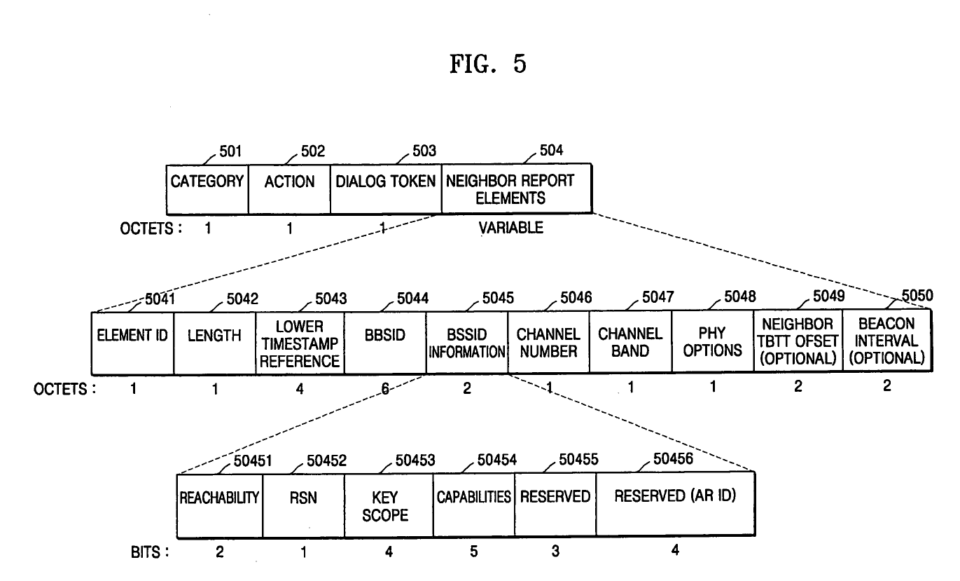

FIG. 5 is a diagram of a neighbor report response frame format according to an embodiment of the present invention. Referring to FIG. 5, the neighbor report response frame comprises a category field 501, an action field 502, a dialog token field 503, and a neighbor report element field 504.

The category field 501 is used to record a radio measurement category value.

The action field 502 is used to record a neighbor report request value.

The dialog token field 503 is used to record a report/request transaction identification value.

The neighbor report element field 504 comprises an element ID field 5041, a length field 5042, a lower timestamp reference field 5043, a basic service set identification (BSSID) field 5044, a BSSID information field 5045, a channel number field 5046, a channel band field 5047, a physical (PHY) option field 5048, a neighbor TBTT offset field 5049, and a beacon interval field 5050.

The BSSID information field 5045 comprises a reachability field 50451, a robust security network (RSN) field 50452, a key scope field 50453, a capabilities field 50454, and reserved fields 50455 and 50456, and is used to assist the mobile node 4 in selecting an access point from a plurality of access points.

The 4-bit second reserved field 50456 is used to record information on a subnet, i.e., information on the ID of an access router that provides routing service in a subnet in which an access point neighboring AP B 52 is located. The access point transmits the ID of an access router connected to the access point along with the neighbor report response frame.

Although an access router ID is used as information regarding a subnet in the present embodiment, it can be understood by those skilled in the art that other data, such as, for instance, a subnet prefix, can be used as information regarding the subnet within the recording space of the reserved field.

When the frame identifier 44 identifies the frame received by the receiver 43 as the neighbor report response frame, the access point selector 45 selects an access point capable of providing the mobile node 4 with the optimum wireless LAN environment from among AP A 51, AP B 52, and AP C 53 based on the neighbor information included in the neighbor report response frame received from AP B 52. The access point selector 45 selects an access point capable of providing the mobile node 4 with the optimum channel environment and performance based on channel information and performance information included in the neighbor report response frame.

The BSS change determiner 46 determines whether to change the BSS in which the mobile node 4 is located according to the selection of the access point selector 45. To be more specific, the BSS change determiner 46 determines that a wireless LAN that is connected to the mobile node 4 is changed when the BSS operated by an access point selected by the access point selector 45 is different from the BSS in which the mobile node 4 was previously located.

The subnet change determiner 47 determines whether to change the subnet in which the mobile node 4 is located according to the selection of the access point selector 45. Since an access router provides routing service in a single subnet, the subnet change determiner 47 determines whether to change the access router to provide the mobile node 4 with routing service according to the selection of the access point selector 45, in order to determine whether to change the subnet. In the present embodiment, the access router ID is included in the neighbor report response frame in order to inform the mobile node 4 of whether to change the subnet in advance.

To be more specific, the subnet change determiner 47 determines that the subnet in which the mobile node 4 is currently located is changed when the subnet in which an access point selected by the access point selector 45 is located is different from the subnet in which an access point which previously communicated with the mobile node 4 is located. In other words, the subnet change determiner 47 determines that the subnet in which the mobile node 4 was previously located is changed when the ID of an access router that provides routing service in the subnet in which the access point selected by the access point selector 45 is located is different from the ID of the access router that provides routing service in the subnet in which the mobile node 4 was previously located.

The handover performer 48 selectively performs handover according to the determination of the BSS change determiner 46 and subnet change determiner 47. The handover performer 48 comprises an L2 handover performer 481 and L3 handover performer 482.

The L2 handover performer 481 selectively performs handover in the link layer according to the determination of the BSS change determiner 46. To be more specific, the L2 handover performer 481 performs handover in the link layer when the ID of the BSS in which the mobile node 4 was previously located is different from the ID of a BSS which the mobile node 4 enters. For example, the L2 handover performer 481 performs handover in the link layer according to whether the mobile node 4 moves from a BSS operated by AP B 52, which communicates with the mobile node 4, to a wireless LAN operated by AP A 51 or AP C 53, which neighbor AP B 52.

The L3 handover performer 482 selectively performs handover in the IP layer according to the determination of the subnet change determiner 47. To be more specific, the L3 handover performer 482 performs handover in the IP layer when the ID of an access router that provides routing service in the subnet in which the mobile node 4 was previously located is different from the ID of an access router that provides routing service in the subnet which the mobile node 4 enters. The L3 handover performer 482 performs handover in the IP layer when the subnet in which the mobile node 4 was previously located is different from the subnet which the mobile node 4 enters.

Referring to FIG. 3 again, the apparatus to perform fast handover comprises a receiver 521, a frame identifier 522, a neighbor information obtainer 523, a frame generator 524, and a transmitter 525. The apparatus to perform fast handover is formed in the link layer of the access point, as illustrated in AP B 52 in FIG. 3.

The receiver 521 receives a frame from the mobile node 4.

The frame identifier 522 determines whether the frame received by the receiver 521 is the neighbor report request frame.

The neighbor information obtainer 523 obtains neighbor information from at least one access point neighboring AP B 52, e.g., AP A 51 and AP C 53. AP A 51, AP B 52 and AP C 53 can communicate one another's information according to an IEEE 802.11 standard-based inter AP protocol (IAPP).

When the frame identifier 522 identifies the frame received by the receiver 521 as the neighbor report request frame, the frame generator 524 generates the neighbor report response frame, including the neighbor information obtained by the neighbor information obtainer 523.

The transmitter 525 transmits the neighbor report response frame generated by the frame generator 524 to the mobile node 4 that is located in the BSS operated by the transmitter 525.

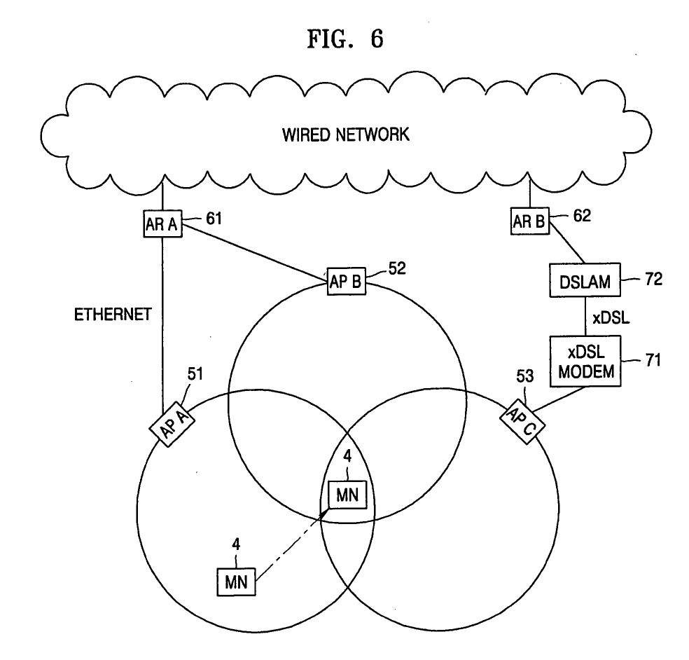

FIG. 6 is a diagram of a hot spot environment to which the wireless LAN environment shown in FIG. 2 is applied. Referring to FIG. 6, the hot spot environment to which the wireless LAN environment shown in FIG. 2 is applied comprises a mobile node 4, an access point A 51, an access point B 52, an access point C 53, an access router A 61, an access router B 62, an x digital subscriber line (xDSL) modem 71, and a digital subscriber line access multiplexer (DSLAM) 72.

Access point A 51, access point B 52, and access router A 61 are connected to one another using Ethernet, and access point C 53 and access router B 62 are connected to each other using xDSL.

The mobile node 4 moves so as to be located at the overlap of the BSS operated by access point A 51, the BSS operated by access point B 52, and the BSS operated by access point C 53. The mobile node 4 selects either access point A 51, access point B 52, or access point C 53, based on neighbor information received from access point A 51 which communicates with the mobile node 4. If the distances between the mobile node 4 and access point A 51, access point B 52, and access point C 53 are equal, the mobile node 4 may select access point B 52, so as not to require a change in the subnet.

The mobile node 4 can select the access point capable of the most effective wireless communication from a plurality of access points that communicate with the mobile node 4, thereby moving to a plurality of BSSs by performing handover requiring limited operation.

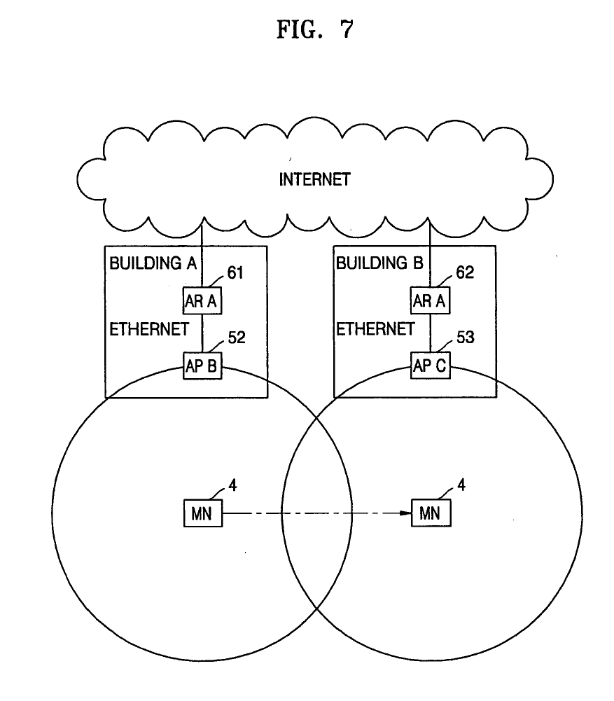

FIG. 7 is a diagram of a university communication environment to which the wireless LAN environment shown in FIG. 2 is applied. Referring to FIG. 7, the university communication environment comprises a mobile node 4, an access point B 52, an access point C 53, an access router A 61, and an access router B 62.

AP B 52 is connected to access router A 61, and AP C 53 is connected to access router B 62, using Ethernet.

Since in the university communication environment every building has a separate subnet, each building has an access router.

The mobile node 4 moves from a BSS operated by AP B 52 to a BSS operated by AP C 53. The mobile node 4 must perform handover in the link layer according to a change in the BSS, and handover in the IP layer according to a change in the subnet. The mobile node 4 simultaneously performs handover in the link layer and handover in the IP layer, thereby greatly reducing the time required to perform handover.

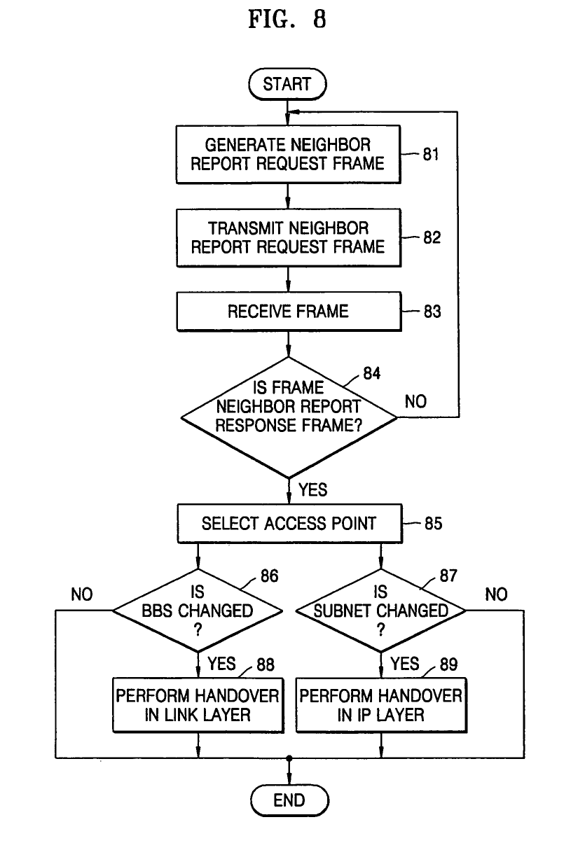

FIG. 8 is a flow chart of a method of performing fast handover according to an embodiment of the present invention. Referring to FIG. 8, the method of performing fast handover comprises operations processed at the apparatus to perform fast handover formed in the mobile node 4 shown in FIG. 3. The foregoing description regarding the apparatus to perform fast handover applies to the method of performing fast handover.

In Operation 81, the mobile node 4 generates the neighbor report request frame in order to request neighbor information obtained by AP B 52 that communicates with the mobile node 4.

In Operation 82, the mobile node 4 transmits the neighbor report request frame to AP B 52.

In Operation 83, the mobile node 4 receives a frame from AP B 52, which received the neighbor report request frame.

In Operation 84, the mobile node 4 determines whether the frame received from AP B 52 is the neighbor report response frame in response to the neighbor report request frame transmitted by the mobile node 4.

In Operation 85, if the frame is identified as the neighbor report response frame, the mobile node 4 selects an access point capable of providing the optimum wireless LAN environment from among AP A 51, AP B 52, and AP C 53 based on the neighbor information included in the neighbor report response frame received from AP B 52.

In Operation 86, the mobile node 4 determines whether to change the BSS according to the selection of Operation 85. The mobile node 4 determines that a wireless LAN that is connected to the mobile node 4 is changed if the BSS operated by the access point selected by the mobile node 4 is different from the BSS in which the mobile node 4 was previously located.

In Operation 87, the mobile node 4 determines whether to change the subnet according to the selection of Operation 85. Since access routers provide routing service in a single subnet, the mobile node 4 determines whether to change an access router to provide the mobile node 4 with routing service according to the selection of Operation 85, in order to determine whether to change the subnet. In the present embodiment, the access router ID is included in the neighbor report response frame in order to inform the mobile node 4 of whether to change the subnet in advance.

To be more specific, the mobile node 4 determines that the subnet in which the mobile node 4 is was previously located is changed when the subnet in which the access point selected in Operation 85 is located is different from the subnet in which an access point which previously communicated with the mobile node 4 is located. The mobile node 4 determines that the subnet in which the mobile node 4 was previously located is changed when the ID of an access router that provides routing service in the subnet in which the access point selected in Operation 85 is located is different from the ID of the access router that provides routing service in the subnet in which the mobile node 4 was previously located.

In Operation 88, the mobile node 4 selectively performs handover in the link layer according to the selection of Operation 86. To be more specific, the mobile node 4 performs handover in the link layer when the ID of the previous BSS in which the mobile node 4 was located is different from the ID of a BSS which the mobile node 4 enters. For instance, the mobile node 4 performs handover in the link layer according to whether the mobile node 4 moves from a BSS operated by AP B 52, which communicates with the mobile node 4, to a wireless LAN operated by AP A 51 or AP C 53, which neighbor AP B 52.

In Operation 89, the mobile node 4 selectively performs handover in the IP layer according to the selection of Operation 87. To be more specific, the mobile node 4 performs handover in the IP layer when the ID of an access router that provides routing service in the subnet in which the mobile node 4 was previously located is different from the ID of an access router that provides routing service in the subnet which the mobile node 4 enters. The mobile node 4 performs handover in the IP layer when the subnet in which the mobile node 4 was previously located is different from the subnet which the mobile node 4 enters.

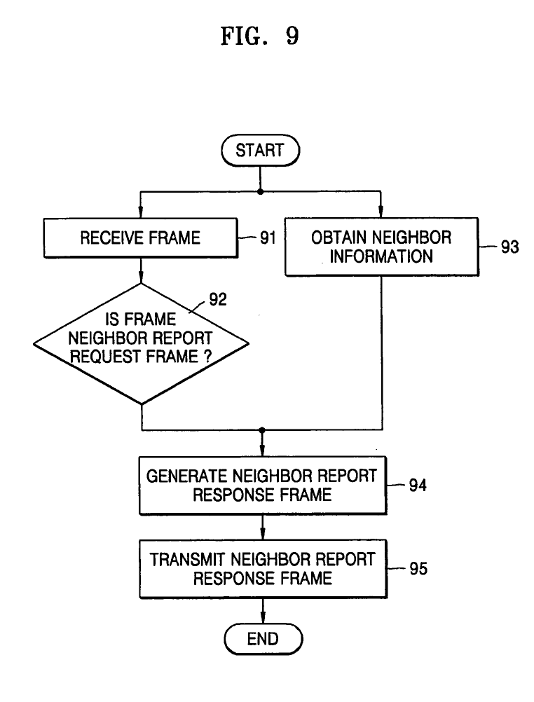

FIG. 9 is a flow chart of a method of supporting fast handover according to an embodiment of the present invention. Referring to FIG. 9, the method of supporting fast handover comprises operations processed at the apparatus to support fast handover formed in AP B 52 shown in FIG. 3. The foregoing description regarding the apparatus to support fast handover applies to the method of supporting fast handover.

In Operation 91, AP B 52 receives a frame from the mobile node 4.

In Operation 92, AP B 52 determines whether the frame received from the mobile node 4 is the neighbor report request frame.

In Operation 93, AP B 52 obtains neighbor information from at least one access point neighboring AP B 52, e.g., AP A 51 and AP C 53.

In Operation 94, if the frame is identified as the neighbor report request frame, AP B 52 generates the neighbor report response frame including the neighbor information obtained in Operation 93.

In Operation 95, AP B 52 transmits the neighbor report response frame to the mobile node 4 that is located in the BSS operated by AP B 52.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

The mobile node according to the present invention utilizes neighbor information received from an access point that communicates with the mobile node, obtained from an access point neighboring the access point that communicates with the mobile node, so as to predict whether to perform handover in the link layer, or handover in both the link layer and the IP layer, without communicating with an access router.

The mobile node can perform handover in the link layer and IP layer using link layer communication between a mobile node and access point, without IP layer communication between the mobile node and an access router.

The mobile node utilizes neighbor information including a BSS ID and access router ID to simultaneously perform handovers in the link layer and IP layer, thereby greatly reducing the time required to perform handover.

The mobile node can select the access point capable of providing the most effective wireless communication from among a plurality of access points that may communicate with the mobile node, thereby moving to a plurality of BSSs by performing handover requiring limited operation. In conclusion, the effects described above allow the mobile node to perform fast handover.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of performing handover in a mobile node, the method comprising:
receiving neighbor information, obtained by a predetermined access point from at least one access point neighboring the predetermined access point, to allow the mobile node to connect to a subnet among a plurality of subnets; and
selectively performing the handover according to a change in the subnet that is connected to the mobile node based on the received neighbor information.

2. The method of claim 1, wherein the neighbor information indicates a subnet in which the neighboring access point is located, and the handover is performed in response to the subnet that is connected to the mobile node being different from the subnet in which the neighboring access point is located.

3. The method of claim 2, wherein the neighbor information comprises an ID of an access router that provides routing service in the subnet in which the neighboring access point is located, and the handover is performed in response to an ID of an access router that provides routing service in the subnet that is connected to the mobile node being different from the ID of the access router included in the neighbor information.

4. The method of claim 3, wherein the ID of the access router indicated in the neighbor information is recorded in a reserved field of a basic service set identification (BSSID) field of a neighbor report component field of an Institute of Electrical and Electronics Engineers (IEEE) 802.11 standard-based neighbor report response frame.

5. The method of claim 1, wherein the handover is performed in a link layer in response to the mobile node moving to a wireless local area network (LAN) operated by the neighboring access point, and the handover is performed in an Internet protocol (IP) layer in response to the subnet that is connected to the mobile node being changed.

6. The method of claim 1, further comprising:
selecting an access point capable of providing the mobile node with the optimum wireless LAN environment, from among the predetermined access point and the at least one neighboring access point, based on the received neighbor information; and
determining whether to change the subnet that is connected to the mobile node according to the selected access point.

7. An apparatus to perform handover in a mobile node, comprising:
a receiver to receive neighbor information, obtained by a predetermined access point from at least one access point neighboring the predetermined access point, to allow the mobile node to connect to a subnet among a plurality of subnets; and
a handover performer to selectively perform the handover according to a change in the subnet that is connected to the mobile node, based on the neighbor information received by the receiver.

8. The apparatus of claim 7, wherein the neighbor information indicates a subnet in which a neighboring access point is located, and the handover performer performs handover in response to the subnet that is connected to the mobile node being different from the subnet in which the neighboring access point is located.

9. The apparatus of claim 8, wherein the neighbor information comprises an ID of an access router that provides routing service in the subnet in which the neighboring access point is located, and the handover performer performs handover in response to the ID of an access router that provides routing service in the subnet that is connected to the mobile node being different from the ID of the access router included in the neighbor information.

10. The apparatus of claim 9, wherein the ID of the access router indicated in the neighbor information is recorded in a reserved field of a basic service and set identification (BSSID) field of a neighbor report component field of an Institute of Electrical and Electronics Engineers (IEEE) 802.11 standard-based neighbor report response frame.

11. A computer readable medium having recorded thereon a computer readable program to perform a method of performing handover in a mobile node, wherein the method comprises:
receiving neighbor information, obtained by a predetermined access point from at least one access point neighboring the predetermined access point, to allow the mobile node to connect to a subnet among a plurality of subnets; and
selectively performing the handover according to a change in the subnet that is connected to the mobile node based on the received neighbor information.

12. A method of supporting handover in a predetermined access point to allow a mobile node to connect to a subnet among a plurality of subnets, the method comprising:
obtaining neighbor information from at least one access point neighboring the predetermined access point; and
transmitting the obtained neighbor information to the mobile node;
wherein the mobile node selectively performs the handover according to a change in the subnet that is connected to the mobile node based on the received neighbor information.

13. The method of claim 12, wherein the neighbor information indicates the subnet in which the neighboring access point is located.

14. The method of claim 13, wherein the neighbor information comprises an ID of an access router that provides routing service in the subnet in which the neighboring access point is located.

15. The method of claim 14, wherein the ID of the access router indicated in the neighbor information is recorded in a reserved field of a basic service set identification (BSSID) field of a neighbor report component field of an Institute of Electrical and Electronics Engineers (IEEE) 802.11 standard-based neighbor report response frame.

16. An apparatus to support handover in a predetermined access point to allow a mobile node to connect to a subnet among a plurality of subnets, the apparatus comprising:
a neighbor information obtainer to obtain neighbor information from at least one access point neighboring the predetermined access point; and
a transmitter to transmit the neighbor information obtained by the neighbor information obtainer to the mobile node;
wherein the mobile node selectively performs the handover according to a change in the subnet that is connected to the mobile node based on the received neighbor information.

17. A computer readable medium having recorded thereon a computer readable program to perform a method of supporting handover in a predetermined access point to allow a mobile node to connect to a subnet among a plurality of subnets, wherein the method comprises:
obtaining neighbor information from at least one access point neighboring the predetermined access point; and
transmitting the obtained neighbor information to the mobile node;
wherein the mobile node selectively performs the handover according to a change in the subnet that is connected to the mobile node based on the received neighbor information.

18. A frame including neighbor information, obtained by a predetermined access point from at least one access point neighboring the predetermined access point, to allow a mobile node to connect to a subnet among a plurality of subnets, the frame comprising:
a field to record an ID of an access router that provides routing service in the subnet in which the neighboring access point is located.

19. A method of performing handover in a mobile node, the method comprising:
selectively performing the handover according to neighbor information received from a predetermined access point, without IP layer communication between the mobile node and an access router;
wherein the neighbor information comprises information regarding at least one access point neighboring the predetermined access point.
